(19) United States
(12) Patent Application Publication
(10) Pub. No.: US 2015/0136760 A1
(43) Pub. Date: May 21, 2015

(54) MICROWAVE OVEN USING SOLID STATE AMPLIFIERS AND ANTENNA ARRAY

(71) Applicants: STMICROELECTRONICS (CANADA), INC., Halifax (CA); STMICROELECTRONICS LTDA, Pinheiros, Sao Paolo (BR)

(72) Inventors: Jose Augusto LIMA, SAO PAULO (BR); AMERICO PAULICCHI FILHO, SAO PAULO (BR)

(21) Appl. No.: 14/538,940

(22) Filed: Nov. 12, 2014

Related U.S. Application Data
(60) Provisional application No. 61/905,059, filed on Nov. 15, 2013.

(51) Int. Cl. H05B 6/68; H05B 6/70; H05B 6/66; H05B 6/64

(52) U.S. Cl. CPC H05B 6/687; H05B 6/6447; H05B 6/705; H05B 6/668; H05B 6/686
USPC 219/709

(57) ABSTRACT

A microwave oven may include a housing defining an oven cavity therein configured to receive material to be heated, and a plurality of solid state microwave generating cells carried by the housing. At least one feedback circuit may be carried by the housing and configured to detect EM radiation within the oven cavity not absorbed by the material to be heated. A processor may be carried by the housing and coupled to the plurality of microwave beamforming cells and to the at least one feedback circuit. The processor may be configured to receive feedback from the at least one feedback circuit based upon the EM radiation not absorbed by the material to be heated, and control phase shifters of the beamforming cells to change the patterns of EM energy transmitted by antennas of the beamforming cells based upon the feedback received from the at least one feedback circuit.

### CROSS-REFERENCE TO RELATED APPLICATIONS

The present application claims priority under 35 U.S.C. §119(e) to the subject matter of U.S. Provisional Patent Application Ser. No. 61/905,059 entitled “MICROWAVE OVEN USING SOLID STATE AMPLIFIERS AND ANTENNA ARRAY,” filed on Nov. 15, 2013, which is hereby incorporated herein in its entirety.

### TECHNICAL FIELD

The present disclosure relates to a microwave oven, and more particularly, to a system and method for implementing beamforming techniques using solid state amplifiers and an array of antennas for heating materials in a microwave oven.

### BACKGROUND

A microwave oven (also referred to as a “microwave”) is a kitchen appliance that heats food using electromagnetic radiation in the microwave spectrum. Microwave ovens heat food quickly. Microwave ovens typically use magnetron technology to create microwave energy in a confined space, which causes a rapid rise in temperature of food placed in the confined space. Microwave ovens that use magnetron technology consume large amounts of power.

Microwave ovens typically include a tube, such as a vacuum tube, and certain microwave ovens include only one vacuum tube. The use of the vacuum tube requires the food to be rotated to be cooked. This rotation is required for the material (i.e., food) to receive relatively uniform energy over the period of heating. To this end, microwave ovens include a mechanical motor to rotate the material to be heated or cooked. However, mechanical motors wear and are a source of frequent failures.

The peak power draw of a magnetron of a microwave is typically about 1.0 kilowatts. An example microwave configuration may include a power supply unit (PSU) of 4 kilovolts (kV) and 300 milliamperes (mA).

Microwave ovens also generally include a relatively large transformer, which increases the weight of the oven. A heavy microwave oven may be more difficult to mount to a wall than a lighter weight microwave, as it is harder to lift and stronger materials may be required to securely mount the oven above a cooking range, for example. The weight of a heavy microwave oven, compared to a lighter weight microwave, may also result in an increase in shipping or transportation costs.

### SUMMARY

A microwave oven may include a housing defining an oven cavity therein configured to receive material to be heated, and a plurality of solid state microwave generating cells carried by the housing. Each cell may include a microwave transmitting antenna to transmit electromagnetic (EM) energy in the microwave spectrum into the oven cavity at the material to be heated, and a respective phase shifter configured to alter a pattern of the EM energy transmitted by the antenna. At least one feedback circuit may be carried by the housing and configured to detect EM radiation within the oven cavity not absorbed by the material to be heated. A processor may be carried by the housing and coupled to the plurality of microwave beamforming cells and to the at least one feedback circuit. The processor may be configured to receive feedback from the at least one feedback circuit based upon the EM radiation not absorbed by the material to be heated, and control the phase shifters of the plurality of beamforming cells to change the patterns of EM energy transmitted by the antennas based upon the feedback received from the at least one feedback circuit.

More particularly, the processor may be configured to control the phase shifters of the plurality of beamforming cells to reduce a power level associated with the EM energy not absorbed by the material to be heated. Furthermore, each beamforming cell may further include a solid state amplifier having an output coupled to the phase shifter. In accordance with another example embodiment, each beamforming cell may further include a solid state amplifier coupled between the phase shifter and the antenna.

The housing may define the oven cavity with a plurality of sidewalls, and the plurality of beamforming cells may include a respective array of beamforming cells carried on a plurality of different sidewalls. Additionally, the at least one feedback circuit may include a respective feedback circuit for each of the arrays of beamforming cells.

In an example embodiment, the microwave oven may further include a digital camera coupled to the processor for capturing digital images of the material within the oven cavity, and a communication interface coupled to the processor to communicate the captured digital images to a user display device. By way of example, the at least one feedback circuit may include a microwave receiving antenna carried by the housing, a buffer amplifier having an input coupled to the microwave receiving antenna and an output, and a power detector having an input coupled to the output of the buffer amplifier and an output coupled to the processor.

The microwave oven may also include a local oscillator carried by the housing and having an output, and a buffer amplifier carried by the housing and having an input coupled to the local oscillator and an output. Furthermore, a power divider may be included having an input coupled to the output of the buffer amplifier and a plurality of outputs each coupled to a respective beamforming cell.

A method for operating a microwave oven, such as the one described briefly above, is also provided. The method may include detecting EM radiation within the oven cavity not absorbed by the material to be heated using at least one feedback circuit carried by the housing, and controlling the phase shifters of the plurality of beamforming cells to change the patterns of EM energy transmitted by the antennas based upon the EM radiation detected from the at least one feedback circuit.

### BRIEF DESCRIPTION OF THE DRAWINGS

FIG. 1 is a block diagram of a conventional microwave oven.

FIGS. 2A is a perspective diagram, and FIG. 2B is a corresponding block diagram, of a microwave oven according to an example embodiment.

FIG. 3A is a schematic circuit diagram of a beamforming circuit of the microwave of FIGS. 2A and 2B in accordance with an example embodiment.

FIG. 3B is a schematic circuit diagram illustrating an example solid state microwave generating cell of the beamforming circuit of FIG. 3A.

FIG. 4 is a schematic circuit diagram illustrating an example solid state microwave generating cell array for the beamforming circuit of FIG. 3A.

FIG. 5 is a schematic diagram of an example one-side cell array for a beamforming configuration in accordance with an example embodiment.

FIGS. 6 through 8 are beamforming diagrams illustrating various beamforming configurations in accordance with example embodiments.

FIG. 9 is a schematic block diagram of a system for monitoring and controlling a microwave in accordance with an example embodiment.

FIG. 10 is a flow diagram illustrating a beamforming method for a microwave oven according to an example embodiment.

### DETAILED DESCRIPTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout, and prime notation and multiple prime notation are used to indicate similarly elements in different embodiments.

Referring initially to FIG. 1, by way of background, a typical microwave oven 100 is first described. During operation, the microwave oven 100 heats material enclosed therein. The microwave oven 100 illustratively includes an oven cavity 110, a rotary plate 120 that causes rotation of food 105 placed atop the rotary plate, and a magnetron 130 that generates electromagnetic waves in the microwave spectrum (also referred to as “microwaves”). A power supply unit (PSU) illustratively includes a transformer 140 that provides electricity to the electrical components of the microwave oven 100, and a mechanical motor 150 rotates the rotary plate 120. By way of example, the microwave oven 100 may consume 1.6 kilowatts (kW) of total power during operation, and the transformer 150 of the PSU 140 may output 4 kV at 300 mA, but other power ratings/levels may be used in different implementations, as will be appreciated by those skilled in the art.

The microwave 100 in the example embodiment includes only a single magnetron 130, which includes a relatively high-power vacuum tube. The microwaves emitted from the magnetron 130 are spread throughout the oven cavity 110. A portion of the microwaves are absorbed by the food 105, causing the food to heat up. The remainder of the microwaves are incident upon the walls and other surfaces of the oven cavity 110, which reflect the microwaves. The reflection of this energy causes losses. Some of the microwaves are reflected several times before reaching the food 105 to be warmed. The magnetron 130 consumes much of the total power that the microwave consumes. Also, the efficiency of the magnetron 130 is typically in a range of 60-70%. During operation, the magnetron consumes a peak power of about 1.0 kW of the 1.6 kW of total power that the microwave oven consumes.

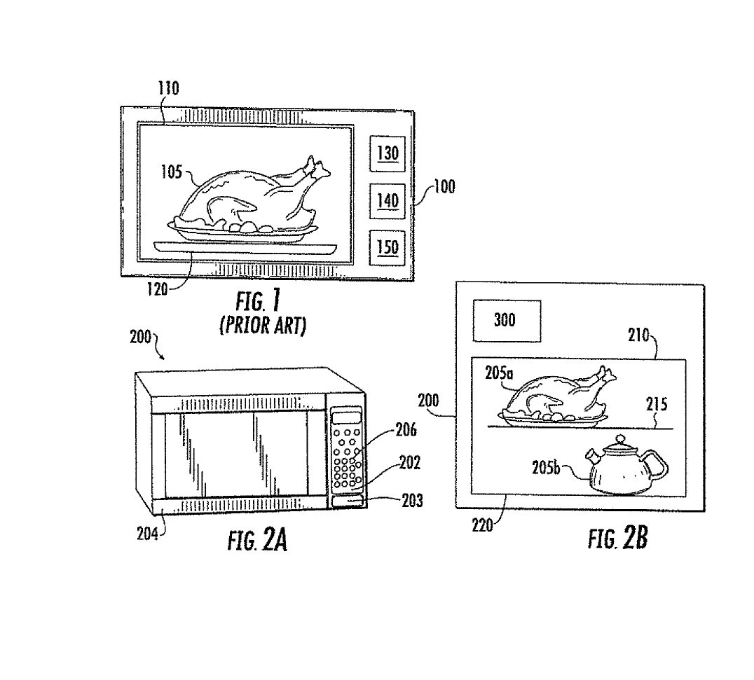

FIGS. 2A and 2B illustrate a microwave oven according to an example embodiment. The microwave oven 200 is configured to cook food and to heat materials placed in the oven cavity 210. In certain embodiments, the microwave oven 200 is configured to cook multiple types of food simultaneously, although this is not required in all embodiments. Although certain details will be provided with reference to the components of the microwave oven 200, other embodiments may include more, less, or different components, as will be appreciated by those skilled in the art.

The microwave oven 200 illustratively includes a user control panel 202 for receiving user selections. A user may press buttons of the user control panel to instruct the microwave 200 to perform desired functions. For example, a user may press a door opening button 202 that causes the door 204 of the microwave to open, as well as control buttons 206 to control cooking operations (time, power levels, etc.) as well as other operations (e.g., clock, timer, etc.).

The door 204 opens to allow the user to place food into the metal oven cavity 210 to be heated. The microwave 200 may be configured not to operate while the door 204 is open to avoid microwave exposure to the user. That is, the user may be required to close the door 204 (as seen in FIG. 2A) before the microwave 200 will heat the food 205a, 205b inside.

In certain embodiments, the microwave door 204 includes a metal safety net or mesh 206 disposed across some or all of the door 204. The safety net 206 catches microwaves incident upon the door that were not absorbed by the food, thereby helping to prevent those microwaves from traveling through the door 202 or otherwise escaping the oven cavity. For example, in certain embodiments, the door 204 may include a clear window fully covered by the safety net 206, allowing the user to look into the oven cavity while the microwave 200 warms the food.

As seen in FIG. 2B, the microwave 200 is configured for heating of multiple types of food 205a, 205b at the same time. The microwave oven 200 may heat foods that require high power at the same time and in the same oven cavity 210 as foods that require low power. For example, chicken and a cup of soup may require the same amount of time to cook. To cook the chicken may require higher power during that amount of time than the lower power required to cook the soup in the same time period. This may be accomplished using the beamforming techniques described below to change the shape and/or intensity of the microwave energy directed at the given food items 205a, 205b.

The oven cavity 210 may be a rectangular prism shape, having a top sidewall, a left sidewall, a right sidewall, a back sidewall, and a bottom 220. For proper use, the user places food on the oven cavity surface of the bottom 220, and not in contact with any sidewalls. In the present disclosure, the sidewalls are referred to as foodless.

The microwave oven 200 includes beamforming circuitry 300 that causes high powered microwaves to be incident upon the food 205a that requires high power for cooking (e.g., chicken). At the same time, the circuitry 300 causes low powered microwaves to be incident upon the food 205b that requires low power for cooking (e.g., water in a kettle). In certain embodiments, the circuitry 300 receives input from a user making selections using the user control panel 206. The input can indicate a level of power to be supplied to food disposed a specified area of the microwave. For example, the user may specify that food 205a placed on a rack 215 (located in a upper level area) in the oven cavity 210 requires high power, while the food 205b placed on a bottom 220 of the oven cavity 210 requires low power, or vice-versa. In another example, the food 205a placed on the left side of the oven cavity 210 requires high power, and that food 205b placed on the right side of the oven cavity 210 requires low power, or vice-versa. The user may specify the level of power by a number of watts, a power level (e.g., 1-10), etc. That is, the oven cavity 210 may be divided into a plurality of different zones or sections in which different levels of microwave intensity is applied to food items therein.

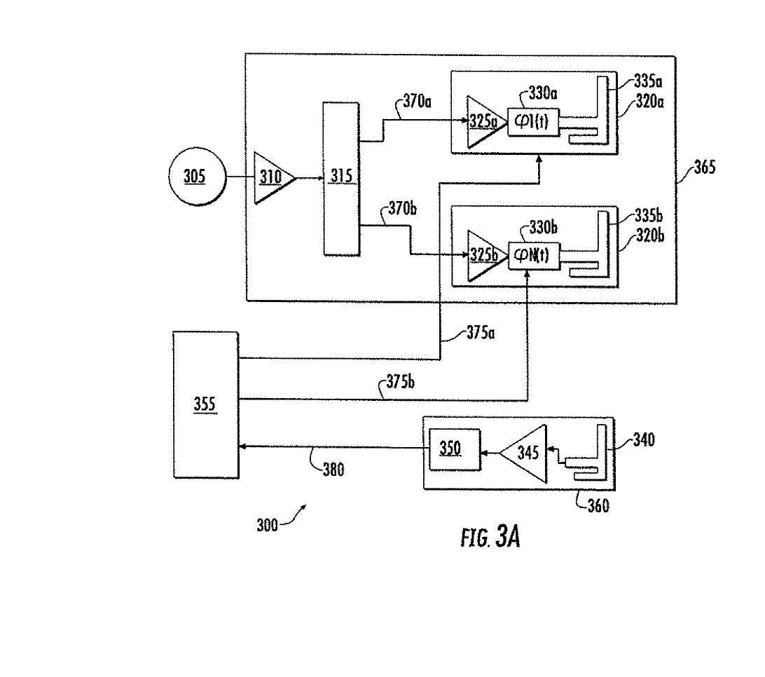

Referring additionally to FIG. 3A, a top level block diagram of a beamforming circuitry 300 which may be used for the microwave 200 to provide the above-noted zones of different microwave intensity is now described. The beamforming circuitry 300 controls internal components of the microwave oven 200. Although certain details will be provided with reference to the components of the beamforming circuitry 300, it should be understood that other embodiments may include more, less, or different components.

The beamforming circuitry 300 illustratively includes a local oscillator 305 coupled to array controlling circuitry 365. The array controlling circuitry illustratively includes a buffer 310 coupled to the local oscillator 305, a power splitter 315 (also referred to as a power divider or radio frequency (RF) coupler) coupled to the output of the buffer, and an array of cells 320a, 320b coupled to respective outputs of the power slitter. Each cell 320a, 320b illustratively includes an amplifier 325a, 325b coupled to a respective output of the power divider 315, a phase shifter circuit block 330a, 330b coupled to the output of the respective amplifier, and a patch antenna 335a, 335b coupled to the respective phase shifter circuit block.

The beamforming circuitry 300 further illustratively includes a feedback circuit 360, and a processing circuit block 355 coupled to the feedback circuit and the array controlling circuit 365. The feedback circuit 360 illustratively includes a sensing antenna 340, a buffer 345 having an input coupled to the sensing antenna, and a power detector 350 coupled to the output of the buffer. The array controlling circuit 365 illustratively includes a single buffer 310, a single power splitter 315, and the two cells 320a and/or 320b, although different numbers of these components may be used in different embodiments. For example, the present disclosure is not limited to a cell array where N equals two, rather any suitable number N of cells may be used, as indicated by the “N(t)” in the Nth phase shifter circuit block 330b.

The local oscillator 305 is coupled to the buffer 310, which is a low power amplifier that buffers signals sent to the power splitter 315. That is, the buffer 310 (e.g., a low power amplifier) distributes power to the power splitter 315. The power splitter 315 sends a signal to each cell 320a, 320b in the array. More particularly, the power splitter 315 sends a first signal 370a to the first cell 320a and sends a second signal 370b to the second cell 320b. The first and second signals 370a, 370b include an amount of power and a phase.

In each respective cell 320a, 320b, the amplifier 325a, 325b receives the signal 370a, 370b. Each amplifier 325a, 325b amplifies the received signal 370a, 370b and outputs the amplified signal to the respective phase shifter circuit block 330a, 330b. That is, the first amplifier 325a amplifies the first signal 370a, and the second amplifier 325b amplifies the second signal 370b. In response to receiving the amplified first signal, the first phase shifter circuit block 330a selectively adjusts the phase of the amplified signal and outputs an amplified, phase shifted signal to the first antenna 335a. In response to receiving the amplified second signal, the second phase shifter circuit block 330b selectively adjusts the phase of the amplified signal and outputs an amplified, phase shifted signal to the second antenna 335b. The patch antennas 335a and 335b are transmitter antennas that transmit electromagnetic waves into the oven cavity 210.

Another example cell embodiment is shown in FIG. 3B, in which the amplifier 325′ is coupled between the phase shifter circuit block 330′ and the patch antenna 335′. For example, in the cell 320′, the phase shifter circuit block 330′ is directly coupled the amplifier 325′, and the amplifier 325′ is directly coupled to the patch antenna 335′. That is, phase shifter circuit block 330′ is indirectly coupled to the patch antenna 335′ through the amplifier 325′ (as an intermediary). In each respective cell 320′, the phase shifter circuit block 330′ receives the signal 370′ from the power splitter 315′. In response to receiving the signal 370′, the phase shifter circuit block 330′ selectively adjusts the phase of the signal 370′ and outputs a phase shifted signal to the power amplifier 325′. The power amplifier 325′ amplifies the received phase shifted signal and outputs an amplified, phase shifted signal to the patch antenna 335′. The patch antenna 335′ is a transmitter antenna that transmits electromagnetic waves into the oven cavity 210′.

The cell 320′ shown in FIG. 3B may potentially be less costly than the cell 320a shown in FIG. 3A. When the amplifier 325′ is coupled between the phase shifter circuit block 330 and the patch antenna 335′, the signal 370′ received by the phase shifter circuit block 330′ has a lower power level compared to the amplified signal received by the phase shifter circuit block 330a output from the amplifier 325a. That is, a phase shifter circuit block 330a which is configured to phase shift high powered signals may cost more than a power phase shifter circuit block 330 configured to phase shift relatively lower powered signals.

The microcontroller 355 controls the amplified, phase-shifted signals sent to each antenna 335a-335b. The microcontroller 355 sends a signal 375a-375b to each phase shifter control block 330a-330b. In response to receiving the control signal 375a, 375b, the phase shift circuit block 330a, 325b determines an amount by which to adjust the amplified signal. In response to receiving the control signal 375, the phase shift circuit block 330 determines an amount by which to adjust the amplified signal.

The microcontroller 355 monitors the microwave energy within the oven cavity 210 based upon feedback signals 380 received from the feedback circuit 360. The sensing antenna 340 is a receiving antenna that receives the microwave energy that reflects in the oven cavity 210, or that is not incident upon the food 205a-205b. In response to receiving microwave energy, the sensing antenna 340 sends a signal to the power detector 350 through the buffer 345. The power detector sends feedback signals 380 to the microcontroller 355 indicating the amount of power received by the sensing antenna 340. The feedback signal may also include information such as the location of the sensing antenna.

As noted above, the microcontroller 355 outputs a control signal 375a to the phase shifter circuit block 330a and outputs a control signal 375b to the phase shifter circuit block 330b. The control signal 375a may be different from the control signal 375. To instruct the phase shifter control circuit block 330a, 330b of a specific phase angle to select, the microcontroller 355 performs calculations “on the fly” using the feedback signal 380. For example, in response to receiving the feedback signals 380 indicating that microwave energy is being sensed from sensing antennas 340 of different sidewalls, the microcontroller 355 sends control signals 375a-375b to control the relative phase delay of the array of cells to narrow the beamform of microwave energy transmitted from the transmit patch antennas 335a-335b toward small dimensioned food, for example. Alternatively, the microcontroller 355 may send control signals 375a-375b to further spread the beam of microwave energy transmitted from the transmit patch antennas 335a-335b toward wide dimensioned food, for example.

In certain embodiments, the feedback circuit 360 may include at least one sensing antenna 340 per sidewall of the microwave. More particularly, the microwave oven 200 may include at least one sensing antenna 340 per sidewall that also includes a cell array of transmit patch antennas 320a, 320b. That is, the microwave oven 200 may be configured for a cell array of transmit patch antennas 320a, 320b to be on each sidewall. In certain embodiments, the door 204 may be considered a sidewall that may include a cell array of transmit patch antennas 320, 320a, 320b. The safety net 206 on the door 204 may optionally be omitted in embodiments when the door 204 includes a cell array of transmit patch antennas. That is, certain embodiments of the microwave oven 200 need not include a safety net 206.

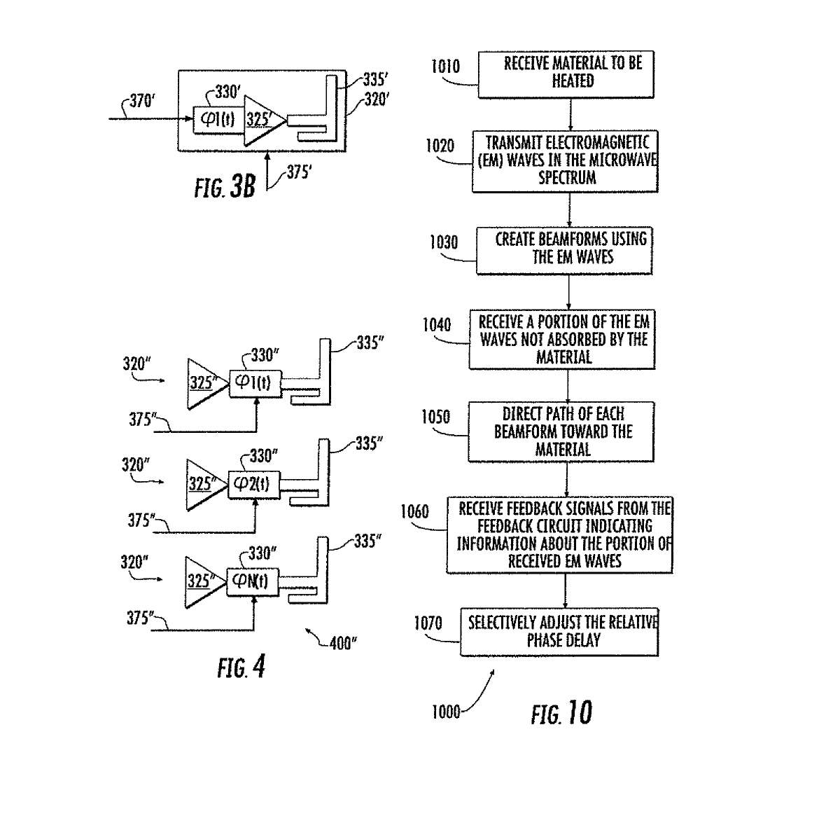

Referring now to FIG. 4, another example cell array 400″ for the microwave oven 200 is now described. The cell array 400″ creates a beamform by changing the phases of each one of the output signals from the patch antennas 320″. The beamform points to food 205a-205b that needs to be cooked. The cell array 400″ illustratively includes a number N of low power cells 320″. The number N may be an integer value of at least one. It should be understood that other embodiments may include more, less, or different components.

The microwave oven 200 may include a cell array 400″ per sidewall. Using several low power amplifiers in the beamforming circuit may result in lower costs compared to a beamforming circuit that includes a single high power amplifier. Moreover, the required transmitted power of the microwave oven 200 is lower than a microwave 100 using a magnetron 130.

A one-side cell array 500 according to an example embodiment is shown in FIG. 5. The one-side cell array 500 illustratively includes sixteen cells. In the present example, each square represents a transmit patch antenna 335′ of a cell. The microwave oven 200 may include a plurality of one-side arrays 500, each for a respective sidewall. A combination of the sixteen cells in the array 500 will provide the beamform from one sidewall. The combination of multiple cells 320 in an array 500 allows each cell 320 to transmit less power. For example, if each cell 320 can produce 20 watts of power, then in combination, the 16 cells of the one-side array 500 produce a beamform of 320 watts of power (20 W×16=320 Watts).

The one-side antenna may have a flat shape, for example. The arrangement of the antenna array may vary in terms of the number of patch antennas 335′ in the array 500, as well as the distance between antennas in the array, as will be appreciated by those skilled in the art.

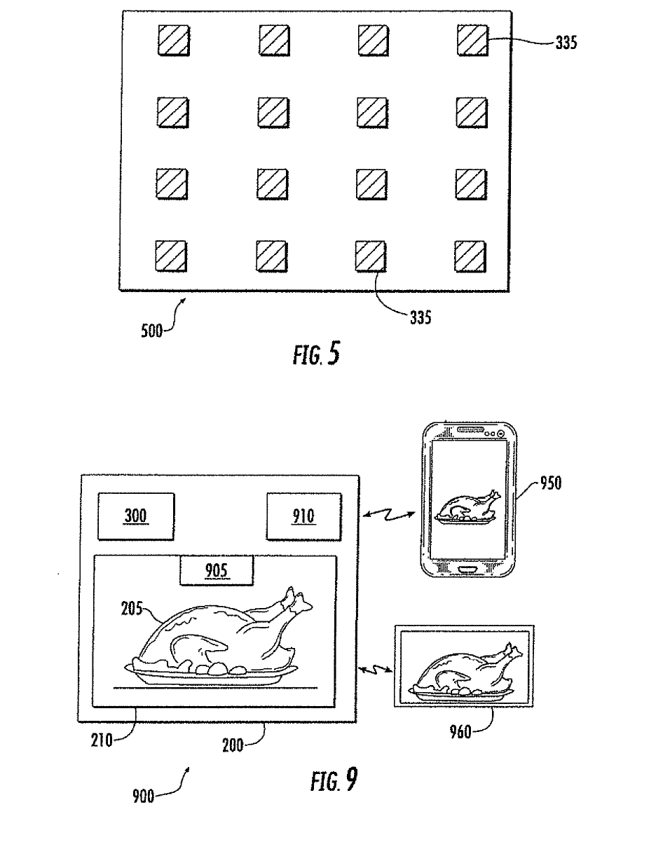

FIGS. 6-8 illustrate example embodiments of beam-forming using the above-described configurations. The examples of FIGS. 6-8 show that the beamform may be adjusted to be more directional by increasing the number of antennas in the array of cells. These examples also show that adjusting the phase at the output of the amplifier causes the beam direction to adaptively change directions. The graphs shown in FIGS. 6-8 were obtained by running a MATLAB script obtained at
http://staff.washington.edu/aganse/src/index.html. The spacing between elements and phase delay are in radians.

More particularly, the example waveform 600 of FIG. 6 was formed using five transmit patch antennas (such as patch antenna 335′, and also referred to as elements) spaced 10 units of length apart (e.g., millimeters or centimeters). The relative phase delay is controlled at −7 radians. The beamform 600 includes microwave signals concentrated along two paths 610 and 620. The direction of the paths 610 and 620 are angled apart by the angle 630, which is an acute angle. The paths 610 and 620 are also angled apart by a second angle 640, which is a reflex angle.

The example waveform 700 of FIG. 7 was formed using five transmit patch antennas (such as patch antenna 335′) spaced 10 units of length apart (e.g., millimeters or centimeters). The relative phase delay is controlled at −2 radians. The beamform 700 includes microwave signals concentrated along two paths 710 and 720. The direction of the paths 710 and 720 are angled apart by the angle 730, which is an obtuse angle. The paths 710 and 720 are also angled apart by a second angle 740, which is an obtuse angle.

In the above-noted example, the microwave oven 200 has a fixed number of transmit patch antennas 335 that are spaced a fixed distance apart. Comparing the beamform 600 to beamform 700 reveals that decreasing the relative phase delay from −2 radians to −7 radians reduces the angle between of the paths of the beamform. Furthermore, increasing the relative phase delay from −7 to −2 radians increases the angle between the paths of the beamform. That is, the angle 730 is greater than the angle 630 as a result of the adjustment of relative phase delay from −2 radians to −7 radians. The beamform 600 may accordingly be applied to cook a wide dimensioned food in the oven cavity 210, for example. The beamform 700 may be applied to cook multiple foods spaced apart from each other in the oven cavity 210, for example.

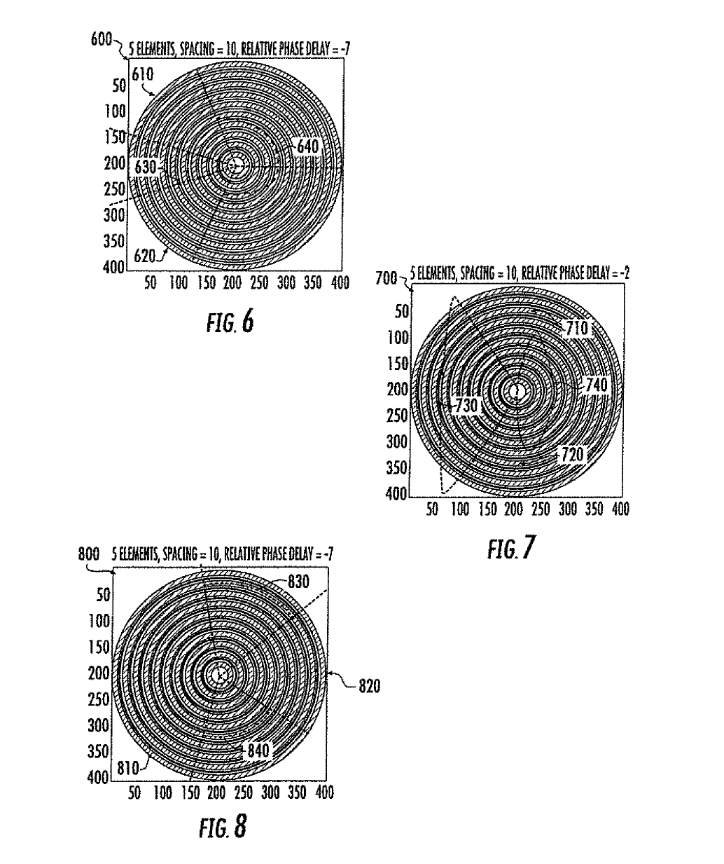

The waveform 800 of FIG. 8 was formed using three transmit patch antennas (such as the patch antenna 335′) spaced 10 units of length apart. The relative phase delay is controlled at −7 radians. The beamform 800 includes microwave signals concentrated along two paths 810 and 820. The direction of the paths 810 and 820 are angled apart by the angle 830, which is an acute angle. The paths 810 and 820 are also angled apart by a second angle 840, which is an acute angle.

From FIGS. 6 and 8 it may be seen that in comparing the beamform 600 to beamform 800, increasing the number of transmit patch antennas from 3 to 5 increases the directionality of the paths of the beamform. Increasing the number of transmit patch antennas from 3 to 5 also causes the paths of the beamform to be narrower and more pointed toward the food to be warmed.

Referring additionally to FIG. 9, a system 900 for monitoring and controlling the microwave 200 according to an example embodiment is now described. The system 900 allows a user to view images captured by a camera 905 in the microwave 200 on a device such as a user mobile device 950 (e.g., mobile phone or tablet computer), and/or a display 960 (for example, a television screen). One or more of the cameras 905 may be disposed within the oven cavity 210 to allow a user to visually monitor the food 205 while it is being cooked in the microwave oven 200. The camera 905 may be a video camera that captures real time images of the food 205, for example.

The system 900 further illustratively includes a communication interface 910 that allows the microwave oven 200 to communicate with a user mobile device 950 (e.g., mobile smartphone, tablet, laptop computer, desktop computer, etc.). A user may control the functions of the microwave 200 using the mobile user device 950 which executes computer readable code configured to generate and send control signals to the microwave oven 200. Communication may be by wireless data transfer, local area network Internet communication, or through an access port provided in the microwave oven 200, such as Universal Serial Bus (USB) port, for example. Communication with the user mobile devices 950 external to the microwave oven 200 allows the user to start or halt operation of the cooking function of the microwave oven 200 without standing near the microwave oven 200. The user may accordingly reduce exposure to microwave energy that may escape the microwave oven 200 by using the monitoring and control system 900 to determine whether the food is thoroughly cooked by viewing real-time images of the food 205 being cooked.

Turning now to FIG. 10, a beamforming method 1000 for operating the microwave oven 200 in accordance with an example embodiment is now described. The beamforming circuitry 300, and more particularly the processor 355, may be implemented with appropriate hardware (e.g., microprocessor, etc.) and a non-transitory computer-readable medium having computer-executable instructions to perform the beamforming operations described herein. At Block 1010, the material 205 to be heated in the oven cavity 210 is inserted into or received in the microwave 200. At Block 1020, an antenna array of N transmit antenna cells transmits electromagnetic (EM) waves in the microwave spectrum within the oven cavity 210. At block 1030, the microprocessor 355 creates one or more beamforms using the EM waves. At the same time, at block 1050, the microprocessor 355 sends control signals 375a, 375b to direct the path of each beamform toward the material by adjusting a relative phase delay of the antenna array, as discussed further above.

Furthermore, the sensing receiver antenna 340 of the feedback circuit(s) 360 receives a portion of the EM waves not absorbed by the material, at Block 1040. The microprocessor 355 receives feedback signals from the feedback circuit 360 indicating an amount of power sensed by the at least one sensing receiver antenna and a location of the at least one sensing receiver antenna, at Block 1060. At Block 1070, in response to receiving the feedback signals, the microprocessor 355 selectively adjust the relative phase delay to reduce at least one of a number EM waves received by the feedback circuit, and a power of the portion of the EM waves not absorbed by the material. The microwave 200 may repeat the functions described above with reference to Blocks 1020-1070 until the microprocessor 355 executes a command to stop operating the cooking function of the microwave oven 200.

Various features and advantages may be provided by the above described system and techniques. Such technical advantages may include: 1) reduction of energy consumption; 2) increases of mean time between failures (MTBF) of a microwave oven; 3) decreases the vibration failure rate present in microwave ovens; 4) elimination of a mechanical motor; and 5) elimination of the need of very high power amplifiers (1000 Watts and beyond). Thus, instead of magnetron technology, embodiments of the present disclosure use solid state technology, which is generally more reliable and consumes less power. Stated alternatively, embodiments of the present disclosure may include semiconductors and antenna arrays instead of tubes (for example, magnetron). This may also avoid the requirement for a relatively large and/or heavy transformer. In addition, the microwave 200 may not require the use of a rotary plate, as even cooking may be achieved through controlling the beamforming arrays rather than having to rotate the food items through an unselective RF field.

With respect to using solid state solutions in microwave ovens instead of using tubes, the challenge of using solid state components is a conventional configuration is the general lack of radio frequency (RF) transistors to support high dissipation and to provide enough irradiated power. However, the present approach may advantageously overcome this challenge by using relatively small power transistors instead of such high power transistors. The amount of energy necessary to cook or warm a dish of food is obtained by a combination of multiple low power components plus beam-forming techniques.

With regard to a reduction of energy consumption during the cooking process, microwave ovens generally spread energy inside a metallic cage (i.e., inside of the oven cavity). By spreading this energy, there is a loss inherent to the bouncing around of this energy. Some of this energy will be reflected several times before it reaches the food to be heated or cooked. The use of beam-forming will provide a microwave beam in the direction of the material (e.g., food) to be heated or cooked. This use of beam-forming mitigates energy losses. Therefore, a lesser amount of energy is required to be irradiated to warm a certain material (e.g., food).

With respect to increasing the mean time between failure (MTBF) of microwave ovens, solid state devices (e.g., transistors) generally have a much better MTBF than an electronic tube (e.g., magnetron). Embodiments of the present disclosure provide a microwave that does not require a mechanical motor that rotates the material (e.g., food) to be warmed. Removing a mechanical component from the microwave 200 also removes the errors or failures caused by that mechanical component. That is, a microwave that does not include a mechanical motor will not be subject to the failures caused by the mechanical motor. Consequently, compared to the microwave with a mechanical motor, the frequency of failures of the microwave without a mechanical motor is reduced, and the time between failures is improved.

As for decreasing the vibration failure rate of microwave ovens, which microwave ovens are subjected to vibrations (e.g., during transportation), their failure rate increases. These vibration-related failures are mostly caused by the failure of the microwave tube installed inside the oven. During transportation of the microwave oven by its owner and without proper packing, the tube is more likely to state failing. Embodiments of the present disclosure use solid state amplifiers instead of vacuum tubes, which help significantly reduce vibration-related failure issues.

With regard to elimination of the mechanical motor, as note above, with the antennas installed on internal sides of the oven cavity and the use of beam-forming methods, the microwave beams will be electronically formed in the direction of the material to be warmed. The techniques of the present disclosure, using beam-forming and placing antennas on the internal walls of the oven, may provide uniform energy for the material to be warmed or cooked relatively easily controlling phases at the output of the amplifiers.

Moreover, the above-described approach may eliminate the need for using very high power amplifiers (e.g., 1000 W and beyond). Here again, the above-noted techniques combine the low irradiated power of each amplifier into the required amount of power necessary to warm up or cook the given material. The techniques of the present disclosure may help eliminate the need to use relatively expensive high amplifiers in 2.4 GHz bands, for example. The techniques described herein accordingly provide an avenue for the transition from vacuums tubes to solid state microwave ovens.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. A microwave oven comprising:
a housing defining an oven cavity therein configured to receive material to be heated;
a plurality of solid state microwave generating cells carried by said housing and each comprising
a microwave transmitting antenna to transmit electromagnetic (EM) energy in the microwave spectrum into the oven cavity at the material to be heated, and
a respective phase shifter configured to alter a pattern of the EM energy transmitted by said antenna;
at least one feedback circuit carried by said housing and configured to detect EM radiation within the oven cavity not absorbed by the material to be heated; and
a processor carried by said housing and coupled to said plurality of microwave beamforming cells and to said at least one feedback circuit and configured to
receive feedback from said at least one feedback circuit based upon the EM radiation not absorbed by the material to be heated, and
control the phase shifters of said plurality of beamforming cells to change the patterns of EM energy transmitted by said antennas based upon the feedback received from said at least one feedback circuit.

2. The microwave oven of claim 1 wherein said processor is configured to control the phase shifters of said plurality of beamforming cells to reduce a power level associated with the EM energy not absorbed by the material to be heated.

3. The microwave oven of claim 1 wherein each beamforming cell further comprises a solid state amplifier having an output coupled to said phase shifter.

4. The microwave oven of claim 1 wherein each beamforming cell further comprises a solid state amplifier coupled between said phase shifter and said antenna.

5. The microwave oven of claim 1 wherein said housing defines the oven cavity with a plurality of sidewalls; and wherein said plurality of beamforming cells comprises a respective array of beamforming cells carried on a plurality of different sidewalls.

6. The microwave oven of claim 5 wherein said at least one feedback circuit comprises a respective feedback circuit for each of said arrays of beamforming cells.

7. The microwave oven of claim 1 further comprising:
a digital camera coupled to said processor for capturing digital images of the material within the oven cavity; and
a communication interface coupled to said processor to communicate the captured digital images to a user display device.

8. The microwave oven of claim 1 wherein said at least one feedback circuit comprises:
a microwave receiving antenna carried by said housing;
a buffer amplifier having an input coupled to said microwave receiving antenna and an output; and
a power detector having an input coupled to the output of said buffer amplifier and an output coupled to said processor.

9. The microwave oven of claim 1 further comprising:
a local oscillator carried by said housing and having an output;
a buffer amplifier carried by said housing and having an input coupled to said local oscillator and an output; and
a power divider having an input coupled to the output of said buffer amplifier and a plurality of outputs each coupled to a respective beamforming cell.

10. A microwave oven comprising:
a housing defining an oven cavity therein with a plurality of sidewalls, the oven cavity configured to receive material to be heated;
a plurality of solid state microwave generating cells carried by said housing and arranged in respective arrays on at least some of said sidewalls, each microwave generating cell comprising
a microwave transmitting antenna to transmit electromagnetic (EM) energy in the microwave spectrum into the oven cavity at the material to be heated, and
a respective phase shifter configured to alter a pattern of the EM energy transmitted by said antenna;
at least one feedback circuit carried by said housing and configured to detect EM radiation within the oven cavity not absorbed by the material to be heated; and
a processor carried by said housing and coupled to said plurality of microwave beamforming cells and to said at least one feedback circuit and configured to
receive feedback from said at least one feedback circuit based upon the EM radiation not absorbed by the material to be heated, and
control the phase shifters of said plurality of beamforming cells to change the patterns of EM energy transmitted by said antennas based upon the feedback received from said at least one feedback circuit to reduce a power level associated with the EM energy not absorbed by the material to be heated.

11. The microwave oven of claim 10 wherein each beamforming cell further comprises a solid state amplifier having an output coupled to said phase shifter.

12. The microwave oven of claim 10 wherein each beamforming cell further comprises a solid state amplifier coupled between said phase shifter and said antenna.

13. The microwave oven of claim 10 wherein said housing defines the oven cavity with a plurality of sidewalls; and wherein said plurality of beamforming cells comprises a respective array of beamforming cells carried on a plurality of different sidewalls.

14. The microwave oven of claim 13 wherein said at least one feedback circuit comprises a respective feedback circuit for each of said arrays of beamforming cells.

15. The microwave oven of claim 10 further comprising:
a digital camera coupled to said processor for capturing digital images of the material within the oven cavity; and
a communication interface coupled to said processor to communicate the captured digital images to a user display device.

16. The microwave oven of claim 10 wherein said at least one feedback circuit comprises:
a microwave receiving antenna carried by said housing;
an buffer amplifier having an input coupled to said microwave receiving antenna and an output; and
a power detector having an input coupled to the output of said buffer amplifier and an output coupled to said processor.

17. The microwave oven of claim 10 further comprising:
a local oscillator carried by said housing and having an output;
a buffer amplifier carried by said housing and having an input coupled to said local oscillator and an output; and
a power divider having an input coupled to the output of said buffer amplifier and a plurality of outputs each coupled to a respective beamforming cell.

18. A method for operating a microwave oven comprising a housing defining an oven cavity therein configured to receive material to be heated, and a plurality of solid state microwave generating cells carried by the housing and each comprising a microwave transmitting antenna to transmit electromagnetic (EM) energy in the microwave spectrum into the oven cavity at the material to be heated, and a respective phase shifter configured to alter a pattern of the EM energy transmitted by the antenna, the method comprising:
detecting EM radiation within the oven cavity not absorbed by the material to be heated using at least one feedback circuit carried by the housing;
controlling the phase shifters of the plurality of beamforming cells to change the patterns of EM energy transmitted by the antennas based upon the EM radiation detected from the at least one feedback circuit.

19. The method of claim 18 wherein controlling the phase shifters comprises controlling the phase shifters to reduce a power level associated with the EM energy not absorbed by the material to be heated.

20. The method of claim 18 wherein each beamforming cell further comprises a solid state amplifier having an output coupled to the phase shifter.

21. The method of claim 18 wherein each beamforming cell further comprises a solid state amplifier coupled between the phase shifter and the antenna.

22. The method of claim 18 wherein the housing defines the oven cavity with a plurality of sidewalls; and wherein the plurality of beamforming cells comprises a respective array of beamforming cells carried on a plurality of different sidewalls.
